(19) United States
(12) Patent Application Publication
(10) Pub. No.: US 2023/0386200 A1
(43) Pub. Date: Nov. 30, 2023

(54) TERRAIN ESTIMATION USING LOW RESOLUTION IMAGERY

(71) Applicant: Microsoft Technology Licensing, LLC, Redmond, WA (US)

(72) Inventors: Roberto DE MOURA ESTEVAO FILHO, Teresopolis (BR); Leonardo DE OLIVEIRA NUNES, Rio de Janeiro (BR); Peder Andreas OLSEN, Redmond, WA (US); Anirudh BADAM, Issaquah, WA (US)

(73) Assignee: Microsoft Technology Licensing, LLC, Redmond, WA (US)

(21) Appl. No.: 17/804,195

(22) Filed: May 26, 2022

(51) Int. Cl. G06V 20/10; G06V 10/60; G06V 10/774

(52) U.S. Cl. CPC G06V 20/194; G06V 10/60; G06V 10/774; G06V 20/188

(57) ABSTRACT

A computing system measures terrain coverage by: obtaining sample image data representing a multispectral image of a geographic region at a sample resolution; generating, based on the sample image data, an index array of pixels for a subject terrain in which each pixel has an index value that represents a predefined relationship between a first wavelength reflectance and a second wavelength reflectance; providing the index array to a trained calibration model to generate an estimated value based on the index array, the estimated value representing an estimated amount of terrain coverage within the geographic region for the subject terrain; and outputting the estimated value for the subject terrain. The trained calibration model may be trained based on training data representing one or more reference images of one or more training geographic regions containing the subject terrain at a higher resolution than the sample resolution.

### BACKGROUND

Satellite and aerial imagery can be used to observe terrestrial and other planetary surfaces for a variety of purposes. The revisit rate of these aeronautical vehicles and the type of on-board sensors can limit the availability and accuracy of surface observations. Extending data collected from these on-board sensors to new detection modalities may improve the availability and accuracy of surface observations.

### SUMMARY

According to an example of the present disclosure, a computing system measures terrain coverage by: obtaining sample image data representing a multi spectral image of a geographic region at a sample resolution; generating, based on the sample image data, an index array of pixels for a subject terrain in which each pixel has an index value that represents a predefined relationship between a first wavelength reflectance and a second wavelength reflectance; providing the index array to a trained calibration model to generate an estimated value based on the index array, the estimated value representing an estimated amount of terrain coverage within the geographic region for the subject terrain; and outputting the estimated value for the subject terrain. As an example, the trained calibration model may be previously trained based on training data representing one or more reference images of one or more training geographic regions containing the subject terrain at a higher resolution than the sample resolution.

According to another example of the present disclosure, a computing system trains a calibration model for measuring terrain coverage of a geographic region by: obtaining a reference image of the geographic region at a reference resolution; determining, based on the reference image, a target value representing an amount of terrain coverage within the geographic region for a subject terrain; obtaining a sample image representing a multispectral image of the geographic region at a sample resolution that is lower than the reference resolution; generating, based on the sample image, an index array of pixels for the subject terrain in which each pixel has an index value that represents a predefined relationship between a first wavelength reflectance and a second wavelength reflectance; providing the index array to the calibration model to generate an estimated value representing an estimated amount of terrain coverage within the geographic region for the subject terrain; determining an error between the target value and the estimated value; and adjusting one or more parameters of the calibration model based on the error to obtain a trained calibration model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts an example of aeronautical vehicles capturing imagery of a geographic region for use by a computing system.

FIG. 2 is a flow diagram depicting an example method for measuring terrain coverage of a subject terrain.

FIG. 3 is a schematic diagram depicting an example processing pipeline 300 of the program suite of FIG. 1, as may be implemented by a computing system.

FIG. 4 is a flow diagram depicting an example method for training the calibration model of FIGS. 1-3.

FIG. 5A depicts examples of image masks of reference images having a reference resolution.

FIG. 5B depicts examples of downsampled images from the image masks of FIG. 5A.

FIG. 5C depicts examples of index arrays generated from sample multispectral images having a sample resolution.

FIG. 6 depicts a table of two sets of example spectral bands that may be measured by multispectral imagery.

FIG. 7 is a schematic diagram depicting additional features of the computing system of FIG. 1.

### DETAILED DESCRIPTION

According to an example of the present disclosure, a calibration model implemented by a computing system generates an estimated value for a subject terrain within a geographic region captured by a sample image. As an example, the subject terrain may include vegetation canopy coverage, and the estimated value may represent a fractional vegetation canopy coverage within the geographic region.

The calibration model may be trained using training data acquired from higher resolution imagery to improve the accuracy of the estimated values generated by the calibration model. The training techniques disclosed herein have the potential to effectively achieve super-resolution of lower resolution sample images. As the revisit rate of aeronautical vehicles can vary across a range of image resolutions, extending lower resolution imagery to new terrain detection modalities has the potential to improve the availability and accuracy of surface observations, including terrain estimation. As an example, images obtained from aeronautical vehicles having a higher revisit rate to a geographic region, but a lower image resolution can be used to estimate terrain coverage for the geographic region based on training data obtained from aeronautical vehicles having a lower revisit rate to the geographic region, but a higher image resolution.

The terrain estimation and training techniques disclosed herein may be used to estimate a variety of terrains. Illustrative examples of terrains that may be estimated using the estimation and training techniques of the present disclosure include: vegetation canopy coverage, species-specific vegetation canopy coverage, bare soil coverage, height threshold-based vegetation (e.g., tree) coverage, etc. The estimation and training techniques disclosed herein may also be used for other forms of terrain estimation, including: average tree height estimation, tree height variance estimation, material composition estimation (e.g., vegetation-based and non-vegetation-based content), as additional examples.

In at least some examples, an index array of pixels may be generated for a subject terrain from a multispectral sample image. As an example, each pixel of the index array may have an index value that represents a relationship between a first wavelength reflectance and a second wavelength reflectance obtained from the multispectral sample image. The index array may be provided as input to the calibration model to generate, as an output, the estimated value for the subject terrain within the geographic region.

A first relationship between inputs to the calibration model (e.g., index arrays) and outputs from the calibration model (e.g., estimated values) may take the form of a first, model-based mapping for the subject terrain. The calibration model may be trained, in this example, by adjusting one or more parameters that define this model-based mapping within the calibration model through regression using a second, reference mapping for the subject terrain. The reference mapping may define a different, second relationship between pixel values of training images and associated ground truth values (e.g., coverage values) for the subject terrain. The phrase “ground truth” within the context of the present disclosure may refer to target values for a subject terrain within a geographic region with respect to which the calibration model is trained to improve accuracy of model.

Target values for the subject terrain may be obtained, in at least some examples, from reference images having a higher resolution than a resolution of the sample images to be evaluated. Training images having the same or similar resolution as the sample image may be obtained by downsampling from the higher resolution reference images. Regression may be used during training to fit or to more closely fit the model-based mapping for the subject terrain to the reference mapping for the subject terrain over the same geographic region, thereby reducing error in estimated values generated by the calibration model following training.

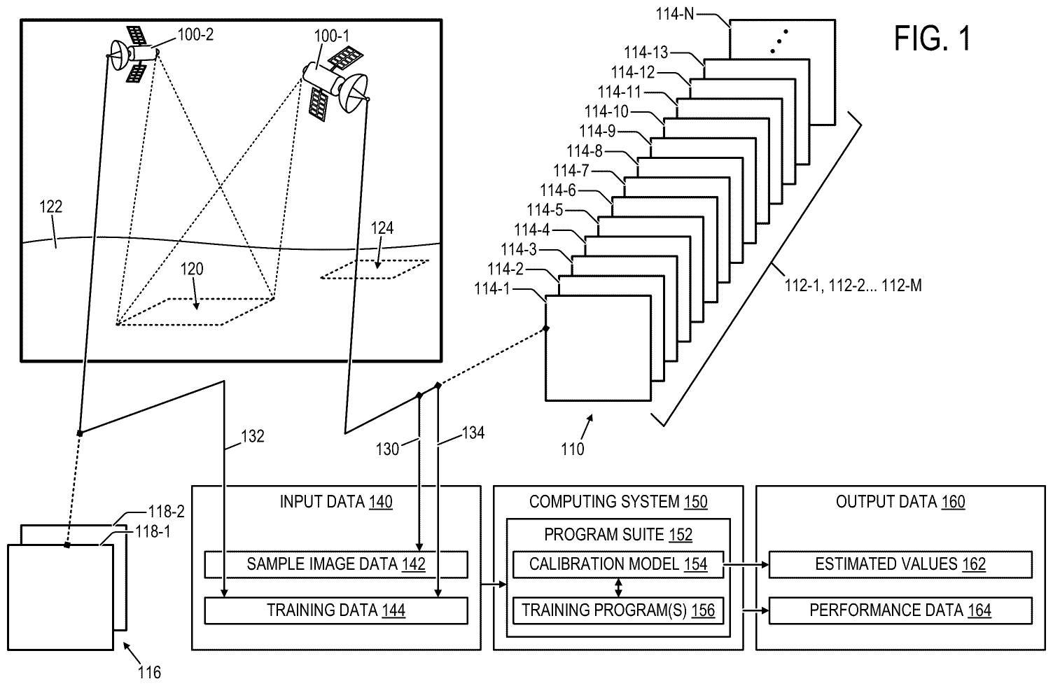

FIG. 1 depicts an example of an aeronautical vehicle 100-1 capturing multispectral imagery 110 of a geographic region 120 of a planetary surface 122. Aeronautical vehicle 100-1, as an example, may take the form of an orbiting satellite or airborne aircraft having one or more on-board imaging sensors (e.g., cameras and/or other optical sensors) by which multispectral imagery 110 is captured.

Multispectral imagery 110 includes a multispectral image 112-1 of geographic region 120. Multispectral image 112-1 may include a plurality of band-specific image components (represented by the quantity “N”) contemporaneously captured by aeronautical vehicle 100-1 of geographic region 120. The N band-specific image components of multispectral image 112-1 are represented schematically in FIG. 1 by band-specific image component 114-1 through band-specific image component 114-N. In this example, the N band-specific image components of multispectral image 112-1 respectively measure reflected radiance of planetary surface 122 within geographic region 120 in N spectral bands.

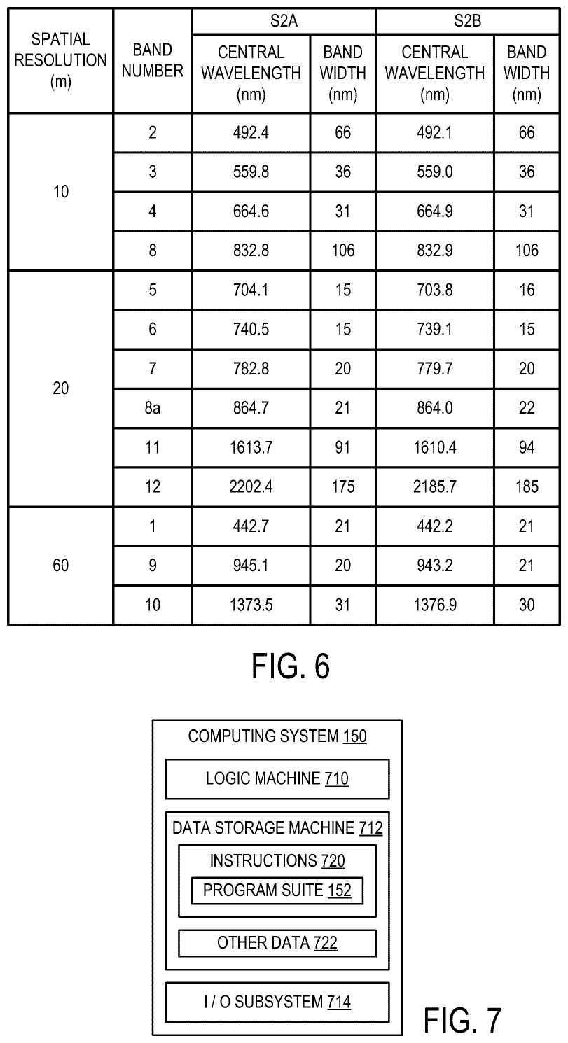

As an illustrative example, aeronautical vehicle 100 may take the form of an orbiting satellite of the Sentinel-2 program having an onboard imaging system referred to as the MultiSpectral Instrument (MSI). The MSI, as an example, captures multispectral imagery that measures the Earth's reflectance in 13 spectral bands, corresponding to 13 band-specific image components (e.g., 114-1 through 114-13). Examples of the 13 spectral bands of the MSI are described in further detail with reference to FIG. 6. It will be understood that the techniques disclosed herein can used with multispectral imagery having any suitable quantity and configuration of spectral bands beyond the examples disclosed herein.

Each multispectral image component (e.g., 114-1 through 114-N) includes a pixel array of band-specific intensity values for a particular spectral band. For example, each band-specific image component (e.g., 114-1 through 114-N) of multispectral image set 112-1 may include a two-dimensional array of pixels having band-specific intensity values at each pixel for a respective spectral band. Each pixel of a band-specific image component may be represented as a vector having a position in a first dimension of the image, a position in a second dimension of the image that is orthogonal to the first dimension, and a band-specific intensity value for that pixel.

Multispectral imagery 110 may include a time-based series of multispectral images (of which multispectral image 112-1 is an example) of diverse geographic regions and/or revisited geographic regions captured over time by aeronautical vehicle 100-1 as the vehicle proceeds along an orbital path or flight path. Thus, for a given geographic region being imaged, a corresponding multispectral image of a plurality of band-specific image components may be obtained. As an example, multiple multispectral images of the same geographic region (e.g., 120) captured at different times can provide a time-based view of surface conditions for the geographic region. As another example, multispectral imagery 110 captured by aeronautical vehicle 110-1 may cover another geographic region 124 of planetary surface 122, which can take the form of another multispectral image.

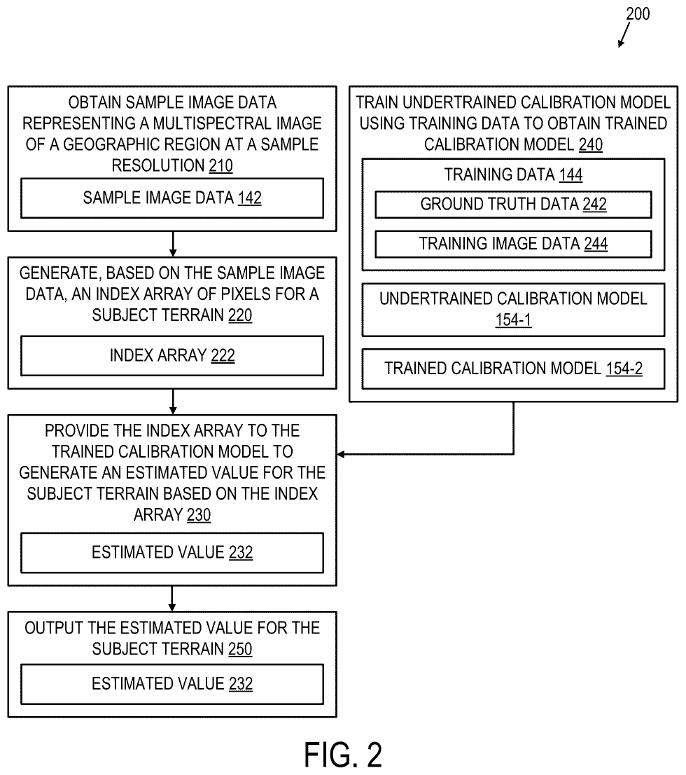

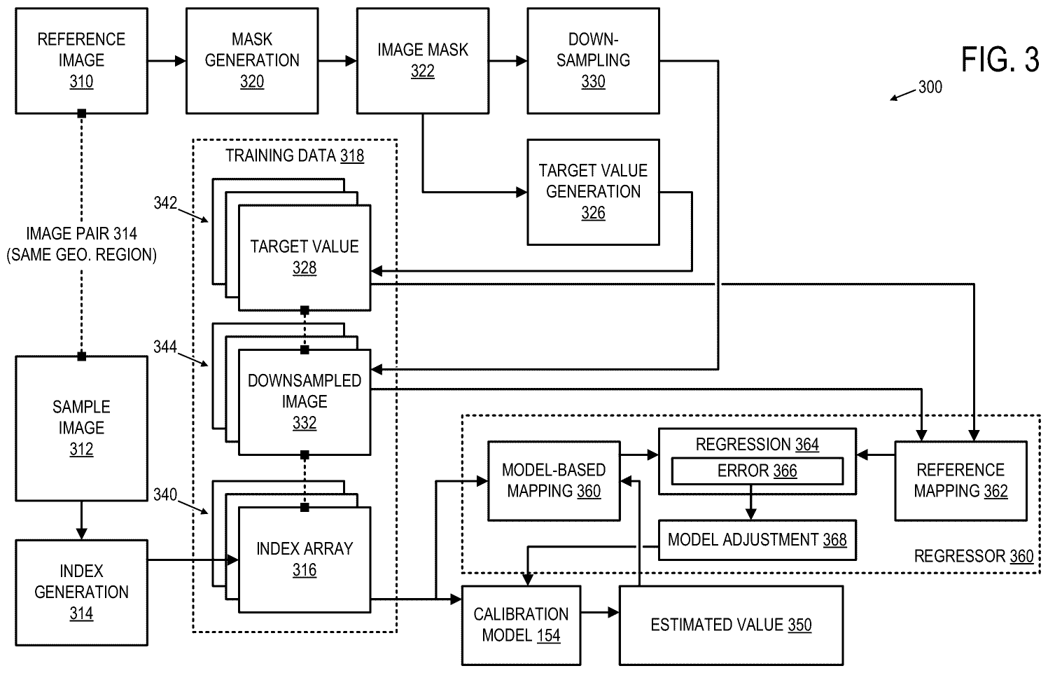

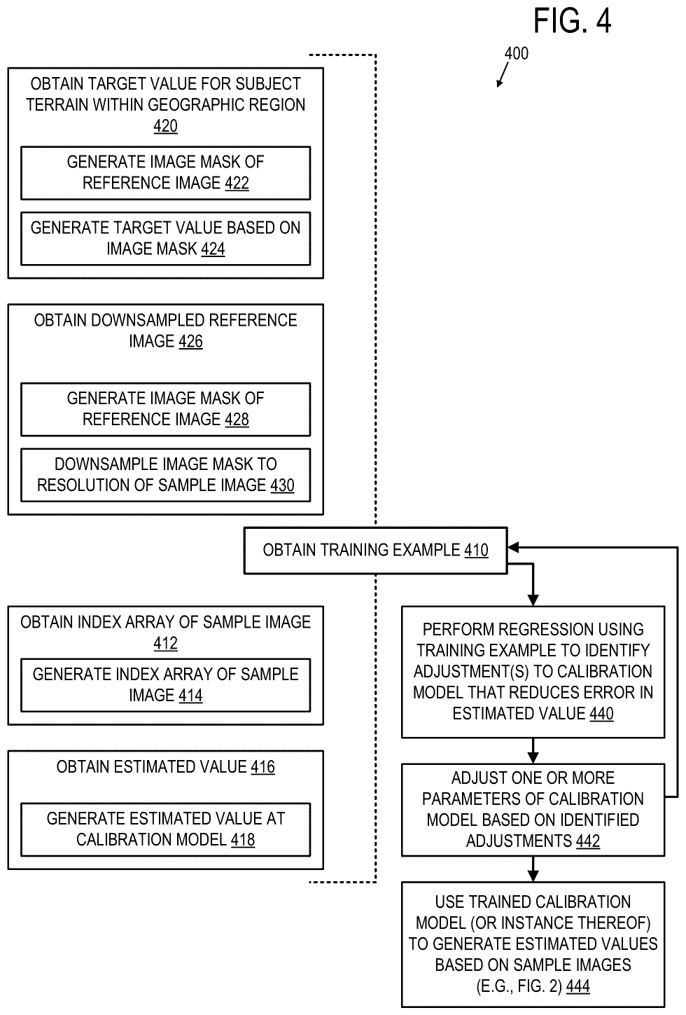

Multispectral imagery 110, including multispectral image 112-1 of geographic region 120 and other multispectral images (e.g., 112-2, 112-M) may be represented by sample image data 142 (schematically depicted by arrow 130 in FIG. 1) that is provided as input data to a computing system for processing. Within FIG. 1, for example, sample image data 142 is received by computing system 150 as input data 140. As described in further detail with reference to FIGS. 2-4, input data 140 received by computing system 150 can include a variety of other input data in addition to sample image data 142. Within the example of FIG. 1, computing system 150 implements a program suite 152 that processes input data 140, including sample image data 142, at a calibration model 154 to generate output data 160 that is based, at least in part, on input data 140. Output data 160, as an example, may include estimated values 162 for a subject terrain generated by calibration model 154 that is based on sample image data 142.

Program suite 152 may further include one or more training programs 156 that are operable to train calibration 154 from an untrained state (an untrained calibration model) to a trained state (a trained calibration model). Training of calibration model 154 may be achieved using a variety of techniques. As an example, training data 144 may be provided to program suite 152 to assess performance of calibration model 154. Performance of calibration model 154 may be represented by performance data 164, as an example of output data 160 generated by computing system 150.

In at least some examples, the one or more training programs 156 may include a regressor as a program component that adjusts one or more parameters of calibration model 154 based on model performance (e.g., as indicated by performance data 164) of the calibration model. As an example, model performance of calibration model 154 may be represented as an error between a ground truth value of coverage for a subject terrain and an estimated value (e.g., of estimated values 162) for the subject terrain that is generated by calibration model 154.

Training data 144 may take various forms, depending on training implementation. As an example, training data 144 may include training imagery 116 of one or more reference images captured at a higher resolution than multispectral imagery 110 of sample image data 142. Within FIG. 1, for example, another aeronautical vehicle 100-2 having a higher resolution camera or other optical sensor may capture a reference image 118-1 of geographic region 120, in which reference image 118-1 has a higher resolution than multispectral image 112-1. In this example, training imagery 116 is included in training data 144 as schematically depicted in FIG. 1 by arrow 132. In at least some examples, the training techniques disclosed herein may use higher resolution reference images (e.g., 118-1, 118-2, etc.) as part of training calibration model 154 to effectively achieve super-resolution of lower resolution imagery (e.g., 110) at the calibration model during runtime to assess estimated values 162.

Training imagery 116 may include a time-based series of images of which reference images 118-1, 118-2, etc. are examples. Training imagery 116 may include reference images of diverse geographic regions and/or revisited geographic regions captured over time by aeronautical vehicle 100-2 as the vehicle proceeds along an orbital path or flight path. Thus, for a given geographic region being imaged, a corresponding reference image may be obtained for training data 144. As an example, reference images 118-1 and 118-2 of the same geographic region (e.g., 120) may be captured at different times to provide a time-based view of surface conditions for the geographic region. As another example, training imagery 116 captured by aeronautical vehicle 110-2 may capture multiple geographic regions 120, 124 of planetary surface 122 (e.g., as reference images 118-1, 118-2, etc.).

In at least some examples, for each geographic region being imaged, each reference image of training imagery 116 may be captured contemporaneously or at least as close in-time as possible (given revisit scheduling of the aeronautical vehicles) to each sample image of multispectral imagery 110 to reduce differences in terrain that may arise over time. For example, vegetation may grow, diminish, or otherwise change over time. By capturing sample images and training images at similar times, similarity in a subject terrain observed within a geographic region may be preserved.

As schematically depicted by arrow 134, training data 144 may also include sample images (e.g., multispectral imagery 110), as previously described. Within the context of training calibration model 154, these sample images included in training data 144 may be referred to as training sample images to distinguish from sample images that are used during runtime of the trained calibration model. Once calibration model 154 has been trained for a subject terrain, the calibration model may be used to generate estimates of terrain coverage (e.g., terrain coverage values) for the subject terrain within other geographic regions beyond the geographic regions imaged by training data 144. In at least some examples, an instance (e.g., a copy) of calibration model 154 in a trained state may be provided to another computing system where the trained calibration model may be implemented to generate estimated values for the subject terrain in other geographic regions based on multispectral sample images of those geographic regions.

FIG. 2 is a flow diagram depicting an example method 200 for measuring terrain coverage of a subject terrain. Method 200 or portions thereof may be performed at or by a computing system, such as example computing system 150 of FIG. 1 implementing program suite 152.

At 210, the method includes, at a computing system, obtaining sample image data (e.g., 142) representing a multispectral image (e.g., 112-1) of a geographic region (e.g., 120) at a sample resolution. As an example, the multispectral image may take the form of a multispectral image captured by the MSI of a Sentinnel-2 program satellite. However, it will be understood that other suitable multispectral images may be used with method 200.

At 220, the method includes, at the computing system, generating an index array 222 of pixels for the subject terrain based on the sample image data. In at least some examples, each pixel of index array 222 has an index value that represents a predefined relationship between a first wavelength reflectance (e.g., measured by a first multispectral image component corresponding to a first band of the multispectral image) and a second wavelength reflectance (e.g., measured by a second multispectral image component corresponding to a second band of the multispectral image). The predefined relationship and the wavelengths of the sample image data that are used to generate the index array may be dependent upon the subject terrain being evaluated. Accordingly, in at least some examples, index values of index array 222 may represent a predefined relationship between other suitable quantities of wavelength reflectances measured within respective bands of a multispectral image, including three or more, four or more, etc. bands. The quantity and selection of bands used to generate index array 222 may depend on the type of subject terrain and the type of index being evaluated.

As an illustrative example, where the subject terrain takes the form of a vegetation canopy cover, the predefined relationship and wavelengths being evaluated may be based on a vegetation index, such as the Normalized Difference Vegetation Index (NDVI) or other suitable indexing technique. NDVI, as an example, defines a relationship between near-infrared reflectance, which is strongly reflected by vegetation, and red reflectance in the visible spectrum, which is strongly absorbed by vegetation. An index value for each pixel may be computed for NDVI using the following predefined relationship: NDVI=(NIR−Red)/(MR+Red), where NIR is the near-infrared wavelength reflectance measured at the pixel and Red is the red (visible) wavelength reflectance measured at the pixel within the multispectral image.

As additional examples suitable for vegetation canopy cover, the Enhanced Vegetation Index (EVI), the Normalized Difference Red Edge (NDRE) index, the Enhanced Normalized Difference Vegetation Index (ENDVI), the Visual Atmospheric Resistance Index (VARI), and the Soil-Adjusted Vegetation Index (SAVI) each define different predefined relationships and/or wavelengths that may be used to generate an index array at operation 222. It will be appreciated that other suitable indexing techniques may be used to generate an index array for other types of subject terrains.

At 230, the method includes, at the computing system, providing index array 222 to a trained calibration model 154-2 (denoting calibration model 154 in a trained state) to generate an estimated value 232 (e.g., as part of estimated values 162 of FIG. 1) based on the index array. As an example, the trained calibration model evaluates the index value for each pixel within the geographic region to generate the estimated value for the subject terrain within the geographic region. The estimated value may represent an estimated amount of terrain coverage (e.g., an estimated terrain coverage value) of the geographic region for the subject terrain. For example, the trained calibration model may generate an estimated value in the form of a percentage of coverage (e.g., 75%) of the geographic region by the subject terrain.

In at least some examples, trained calibration model 154-2 may be previously trained from an untrained state (denoted as undertrained calibration model 154-1) based on training data 144. In relation to a trained calibration model, an untrained calibration model refers to a calibration model that has not been trained as well as a partially trained or undertrained calibration model. Training of the calibration model may be performed at a different computing system from the computing system that generates the estimated value, in at least some examples. As an example, an instance of the calibration model may be trained at a first computing system, and following training of the calibration model, another instance (e.g., a copy) of the trained calibration model may be implemented at a second computing system to generate estimated value 232.

In at least some examples, calibration model 154 generates the estimated value by applying a function to the index value for each pixel of the index array to compute a contribution to the estimated value by that pixel. The estimated value may be computed by calibration model 154 as a summation or filtered combination of the contributions from each pixel of the index array. The function applied to the index values may include linear and/or non-linear components, depending on terrain and/or index type. The function applied to the index values may include one or more weights (e.g., coefficients) that may be adjusted during training of calibration model 154 to reduce error of the model in generating the estimated value.

In at least some examples, training data 144 may include ground truth data 242 and/or training image data 244. As an example, training image data 244 may include data derived from one or more training images of one or more training geographic regions containing the subject terrain at a higher resolution than the sample resolution of sample image data 142. Training images of training image data 244 may be associated with ground truth data 242 (e.g., as training labels defining target values), in at least some examples. As an example, ground truth data 242 may represent, for each training image, a target value (e.g., a target coverage value) of the subject terrain within a training geographic region. As described in further detail with reference to FIGS. 3 and 4, ground truth data 242 may be obtained from training image data 244, in at least some examples.

At 250, the method includes outputting, at the computing system, estimated value 232 for the subject terrain. As an example, the computing system may output estimated value 232 via a user interface. As another example, the computing system may output estimated value 232 to data storage or to another process implemented by the computing system or another computing system. In at least some examples, estimated value 232 may be output with an identifier of the geographic region and/or an identifier of the sample image of the sample image data.

FIG. 3 is a schematic diagram depicting an example processing pipeline 300 of program suite 152 of FIG. 1, as may be implemented by computing system 150, as an example.

Within the example of FIG. 3, a reference image 310 (e.g., image 118-1) of a geographic region (e.g., 120) having a higher, reference resolution, and a sample image 312 (e.g., multispectral image 112-1) of the geographic region (e.g., 120) having a lower, sample resolution are obtained as input data 140. Images 310 and 312 may be referred to as an image pair 314 for purposes of training calibration model 154, and may form part of a training example of a plurality of training examples used to train the calibration model. As previously described, it may be advantageous that images 310 and 312 of image pair 314 are captured contemporaneously to minimize or otherwise reduce the extent of changes to the subject terrain within geographic regions that may occur over time, for training purposes. During training of calibration model 154, the geographic regions captured by the reference images and the source images may be referred to as training geographic regions to distinguish these regions from geographic regions that are evaluated during runtime of the calibration model, following training.

Sample image 312 (as a training sample image) may be processed at index generation 314 to generate an index array 316 (e.g., index array 222 of FIG. 2), which may be added to training data 318 as part of a training example. Sample image 312 may take the form of a multispectral image, such as image 112-1 of FIG. 1, as an example. Index array 316 (as a training index array) may be generated as previously described with reference to operation 220 of FIG. 2. In at least some examples, index generation 314 may be performed by a front-end process of calibration module 154 or by a separate program component of program suite 152. As previously described with reference to operation 220, for at least some terrain types, each pixel of index array 316 may have an index value that represents a predefined relationship between a first wavelength reflectance and a second wavelength reflectance for the subject terrain being evaluated.

Reference image 310 may be processed to generate additional training data 318. In at least some examples, reference image 310 may be processed by mask generation 320 to obtain an image mask 322. As an example, image mask 322 may take the form of a binary image mask in which each pixel of the reference image has one of two binary values (e.g., 0 and 1). However, it will be understood that other suitable image mask techniques may be used that do not involve binary pixel values. As an example, pixel values of image mask 322 may take the form of an integer, floating point, etc. Furthermore, in other examples, image mask 322 may not be generated for a training example.

Generation of image mask 322 may be based on the subject terrain for which calibration model is being trained. As an example, image mask 322 may be generated at 320 by applying the same index generation technique as described at operation 314 (which itself may be dependent on the subject terrain) to reference image 310 to generate an index array for the reference image. In this example, the index array generated for reference image 310 is of higher resolution than index array 316 generated for sample image 312.

In at least some examples, a threshold may be applied at mask generation 320 to the index array for reference image 310 to generate image mask 322. For a binary image mask, as an example, pixels of the index array having index values lower than a threshold may be assigned a first value (e.g., a first binary value=0), and pixels of the index array having index values higher than the threshold may be assigned a second value (e.g., a second binary value=1). It will be understood that other suitable techniques may be used to generate image mask 322, including techniques that do not rely upon an intermediate index array as described in the example above.

As another example, image mask 322 or an index array from which image mask 322 may be generated may be obtained from a third-party source as an input to program suite 152.

Mask generation 320 may be implemented as a program component of program suite 152, as a component of training programs 156, and/or may utilize other program components such as index generation 314, as examples.

In at least some examples, image mask 322 or an intermediate index array used to generate image mask 322 may be processed at target value generation 326 to generate a target value 328 for the subject terrain within the geographic region. Target value 328 may represent a ground truth value (e.g., a ground truth coverage value) for the subject terrain within the geographic region for reference image 310 and for image pair 314. Target value 328 may be added to training data 318 to form part of a training example.

As an example, where image mask 322 is a binary image mask, target value generation 326 may generate target value 328 by computing a ratio of a quantity of pixels having a first binary value (e.g., 0) to a quantity of pixels having a second binary value (e.g., 1).

As another example, target value generation 326 may generate target value 328 based on an intermediate index array of reference image 310. In this example, the index array of reference image 310 may be provided as an input to calibration model 154 to generate the target value for the subject terrain within the geographic region. Because target value 328 in these examples is based on reference image 310 having a higher resolution than sample image 312, the target value 328 is likely to be more accurate than an estimated value generated by the calibration model for the lower resolution sample image.

In other examples, target value 328 may be obtained from other sources than reference image 310 or processed forms thereof (e.g., image mask 322 or an intermediate index array). As an example, target value 328 may be obtained from direct, terrestrial-based measurements of the subject terrain, such as during a time contemporaneous with the capture of reference image 310. As yet another example, target value 328 may be obtained from reference image 310 using other suitable techniques without the target value being based on image mask 322 or an intermediate index array.

Downsampling 330 of image mask 322 (or of reference image 310) may be performed to generate a downsampled image 332 having a lower resolution than reference image 310 and image mask 322. In at least some examples, downsampled image 332 may be downsampled at 330 to have the same resolution as subject image 312 and its index array 316. As an example, downsampling at 330 may be performed by computing an average pixel value for each pixel of downsampled image 332 based on two or more corresponding pixels of the higher resolution reference image 310. However, other suitable downsampling techniques may be used to generate downsampled image 332. As examples, a variety of different functions can be used to convert from a higher resolution reference image or mask thereof to the downsampled image having the sample resolution. Within the context of fractional vegetation coverage, averaging pixel values of the reference image as part of downsampling provides a suitable approach since the underlying image mask denotes where vegetation is present in the image, and the average is capable of capturing the vegetation index.

Downsampled image 322 may be added to training data 318 as part of a training example that further includes target value 328 and index array 316. Downsampling at 330 may be performed by or form part of the one or more training programs 156 or may form a separate program component of program suite 152, as examples.

For each image pair (e.g., 314), training data 318 may include an index array (e.g., 316), a target value (e.g., 328), and a downsampled image (e.g., 332) to form a training example for calibration model 154. In at least some examples, a plurality of image pairs may be used to generate a plurality of training examples to train calibration model 154 for a subject terrain. Accordingly, where training is performed on calibration model 154 using a plurality of training examples, training data 318 may include a plurality of index arrays 340 of which index array 316 is an example, a plurality of target values 342 of which target value 328 is an example, and a plurality of downsampled images 344 of which downsampled image 332 is an example.

As part of training calibration model 154, index array 316 may be provided to the calibration model to generate an estimated value 350 (as a training estimated value), for example, as previously described with reference to estimated value 232 of FIG. 2. As previously described with reference to operation 230 of FIG. 2, the calibration model may evaluate the index value for each pixel of index array 316 to generate estimated value 350 for the subject terrain within the geographic region. Estimated value 350 may represent an estimated amount of terrain coverage of the geographic region for the subject terrain. For example, the trained calibration model may generate estimated value 350 in the form of a percentage of coverage (e.g., 75%) of the geographic region by the subject terrain.

While the preceding example includes providing index array 316 generated from two or more different wavelength reflectance to calibration model 154, in other examples, two or more multispectral image components of different spectral bands may be independently provided to calibration model 154 to generate estimated value 350. In these examples, the calibration model may be configured to generate estimated value 350 based on the two or more multispectral image components as input to the model rather than being based on index array 316. Training and runtime use of this type of calibration model may similarly rely on the two or more multispectral image components as input to generate the estimated value.

In at least some examples, the one or more training programs 156 may include a regressor 360 that adjusts one or more parameters (e.g., weights) of calibration model 154 during training. Over one or more training examples, regressor 360 may learn or otherwise identify a model-based mapping 360 that represents a relationship between pixel values of index array 316 as the input to calibration model 154, and estimated value 350 as the output from the calibration model. Over one or more training examples, regressor 360 may learn or otherwise identify a reference mapping 362 that represents a relationship between pixel values of downsampled image 332 and target value 328.

For each training example, regressor 360 may identify an error 366 (e.g., by computing a loss function) between estimated value 350 of model-based mapping 360 and target value 328 of reference mapping 362. Regressor 360 may seek to reduce error 366 by performing model adjustment 368 on one or more parameters (e.g., weights) of calibration model 154. As an example, parameters of calibration model 154 may include weights implemented within one or more functions of calibration model 154 that are applied to index values of the index array.

In at least some examples, regressor 360 may identify one or more parameters of the calibration model for adjustment and a magnitude of the adjustment by fitting features of model-based mapping 360 to reference mapping 362 over one or more training examples. The one or more parameters adjusted through model adjustment 368 may result in a change to the model-based mapping 360 for future processing of index arrays 340 by calibration model 154 and by which estimated values may be generated by calibration model 154.

While training examples are described above as including an index array (e.g., 316), a target value (e.g., 328), and a downsampled image (e.g., 332), training examples may be used to train calibration model 154 that include only a subset of these training example components. As an example, training examples may include an index array (e.g., 316) and a target value (e.g., 328), but may not include a downsampled image (e.g., 332). In this example, regressor 360 may adjust one or more parameters of calibration model 154 to reduce error 366 between the target value and the estimated value over one or more training examples.

Regressor 360 may take a variety of forms, depending on implementation and/or terrain type. Examples of regressors that may be suitable for training calibration model 154 include linear regressors over polynomial features, linear regressors with other types of features, isotonic regressors, multivariate adaptive splines, neural networks regressors trained with gradient descent, ridge regressors, etc. As previously described, regressor 360 may form part of the one or more training programs 156. In runtime deployments, calibration model 154 in a trained state or an instance thereof may be implemented at a computing system without the one or more training programs 156 to generate estimated values for sample images or their index arrays.

FIG. 4 is a flow diagram depicting an example method 400 for training calibration model 154 described herein with reference to FIGS. 1-3. Method 400 or portions thereof may be performed at or by a computing system, such as example computing system 150 of FIG. 1 implementing program suite 152, including the one or more training components 156.

At 410, the method includes obtaining a training example. As previously described with the example of FIG. 3, a training example may include one or more of: (1) a target value for a subject terrain within a geographic region, (2) a downsampled reference image of the geographic region, (3) an index array of a sample image of the geographic region, as well as an estimated value for the subject terrain within the geographic region generated by the calibration model based on the index array.

At 412, the method includes obtaining an index array of the sample image of the geographic region. As part of operation 412, the method at 414 may include generating the index array of the sample image, such as previously described with reference to operation 220 of FIG. 2 and index generation 314 of FIG. 3.

At 416, the method includes obtaining an estimated value for the subject terrain within the geographic region. As part of operation 416, the method at 418 may include generating the estimated value at the calibration model, such as previously described with reference to operation of 230 and calibration model 154 of FIG. 3.

At 420, the method includes obtaining the target value for the subject terrain within the geographic region. As part of operation 420, the method at 422 may include generating an image mask of a reference image, and generating a target value based on the image mask, at 424. As an example, mask generation may be performed as described at 320 and target value generation may be performed as described at 326 of FIG. 3.

At 426, the method includes obtaining the downsampled reference image of the geographic region. As part of operation 426, the method at 428 may include generating the image mask of the reference image, such as previously described at operation 422. Additionally, at operation 430, the method may include downsampling the image mask to the resolution of the sample image, such as previously described at downsampling 330 of FIG. 3.

At 440, the method includes performing regression using the training example to identify one or more adjustments to the calibration model that reduces error (e.g., error 366 of FIG. 3) in the estimated value for the subject terrain within the geographic region. As an example, regression performed at operation 440 may correspond to regression 364 performed by regressor 360.

At 442, the method includes adjusting one or more parameters of the calibration model based on the one or more adjustments identified at operation 440. As an example, model adjustment at 368 by regressor 360 may be used to obtain a trained or further trained calibration model 154 from an untrained state. From operation 442, the method may return to perform additional training of the calibration model using additional training examples. In at least some examples, training of the calibration model may be discontinued when the error (e.g., error 366) is less than a threshold value over one or more training examples.

Following adequate training of the calibration model (e.g., based on reduction of the error to a threshold level), the method at 444 includes using the trained calibration model (or an instance thereof) to generate estimated values for the subject terrain within geographic regions based on sample images. As an example, operation 444 may include preforming operations 210, 220, 230, and 250 of FIG. 2 using trained calibration model 154-2.

The techniques disclosed herein with respect to FIGS. 1-4 may be used in a variety of terrain estimation contexts. As an example, estimation of species-specific vegetation canopy coverage may be achieved by use of indices (e.g., for generating index arrays 222 and 316) that are specific to a particular vegetation species. In this example, the index arrays that are generated from multispectral sample images and/or reference images may be based on a predefined relationship for the vegetation species that considers as input one or more wavelength reflectances suitable for detection of that vegetation species.

As another example, crop water stress, chlorophyll absorption (e.g., chlorophyll absorption index) by vegetation, and/or nitrogen content of vegetation may be estimated by training a calibration model using ground truth values obtained from destructive phenotyping of a plant from each plot of a plurality of plots with different vegetation varieties. Alternatively or additionally, indices of these variables may be obtained from higher resolution, reference imagery, which may be used to train the calibration model.

As another example, estimation of bare soil coverage (e.g., as a factional amount or average amount) may be achieved by use of indices for training and processing sample imagery that are specific to specific soil types or a range of soil types.

As another example, average, variance, and/or threshold-based tree height estimation within a geography region may be achieved using tree heights obtained from higher resolution reference images to train a calibration model suitable for generating estimates of average, variance, or threshold-based tree height in lower resolution sample images.

As another example, material composition may be estimated through hyperspectral analysis of multispectral imagery. In this example, higher resolution, hyper-spectral images (e.g., higher spatial resolution and/or greater spectral resolution in terms of the quantity of spectral bands) may be used to obtain ground truth values for purposes of training a calibration model. A fractional material content may be estimated for a geographic region using lower density multi-spectral images (e.g., lower spatial resolution and/or less spectral resolution) following training of the calibration model.

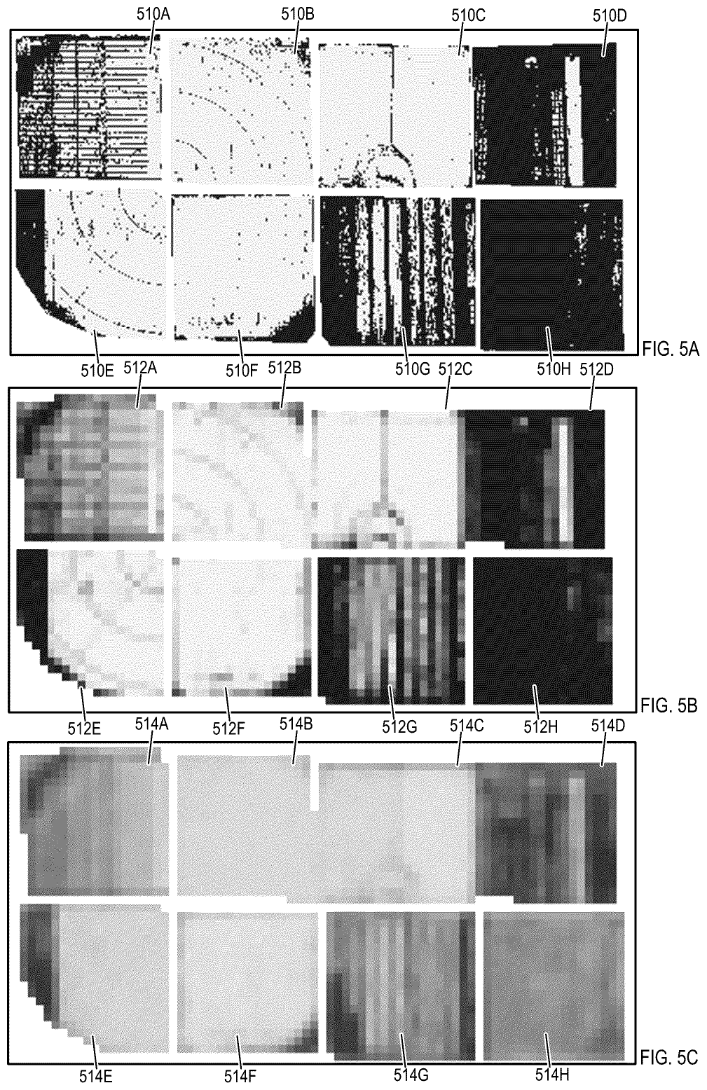

FIG. 5A depicts examples of image masks 510A-510H of reference images having a higher, reference resolution, such as described with reference to image mask 322 of FIG. 3.

FIG. 5B depicts examples of downsampled images 512A-512H from the image masks of FIG. 5A, such as described with reference to downsampled image 332 of FIG. 3. As an example, downsampled image 512A corresponds to image mask 510A after being downsampled to the sample resolution.

FIG. 5C depicts examples of index arrays 514A-514H generated from sample multispectral images having a sample resolution, such as described with reference to index arrays 222 of FIG. 2 and 316 of FIG. 3. As an example, index array 514A corresponds to the same geographic region as image mask 510A of FIG. 5A and downsampled image 512A of FIG. 5B. As another example, index array 514H corresponds to the same geographic region as image mask 510H of FIG. 5A and downsampled image 512H of FIG. 5B

FIG. 6 depicts a table of two sets of 13 spectral bands of the Sentinel-2 program's MSI that may be captured via a multispectral image (e.g., as sample image data 142 of FIGS. 1 and 2 and sample image 312 of FIG. 3. A first set of 13 spectral bands designated as S2A (a first satellite) are identified by a corresponding band number and are each defined by a central wavelength and bandwidth for that central wavelength. A second set of 13 spectral bands designated as S2B (a second satellite) are also identified by a corresponding band number and are each defined by a central wavelength and bandwidth.

A spatial resolution is also identified for each band number within the table of FIG. 6. For example, a spatial resolution of 10 m may refer to each pixel of the band-specific image representing approximately a 10 m×10 m region. The estimation and/or training techniques disclosed herein can use multispectral imagery having diverse spatial resolution across spectral bands, such as the 10 m, 20 m, and 60 m resolutions identified by FIG. 6. As previously described with reference to FIG. 1, the 13 spectral bands identified by the table of FIG. 6 are example spectral bands that can correspond to band-specific image component 114-1 through band-specific image component 114-13 of multispectral image 112-1.

As previously described with reference to FIG. 3, reference images (e.g. 310) used for training calibration model 154 may have a higher resolution than sample images (e.g., 312). Accordingly, the reference images used for training of calibration model may have a higher resolution than the examples depicted in FIG. 6. As an example, the reference images used for training the calibration model may have a spatial resolution of 1 m, 0.1 m, or other suitable resolution.

The methods and processes described herein may be performed by a computing system of one or more computing devices. In particular, such methods and processes may be implemented as a computer-application program or service, an application-programming interface (API), a library, and/or other computer-program product.

FIG. 7 is a schematic diagram depicting additional features of computing system 150 of FIG. 1 that can enact one or more of the methods and processes described herein. Computing system 150 is shown in simplified form. Computing system 150 may take the form of one or more personal computers, server computers, tablet computers, network computing devices, mobile computing devices, mobile communication devices (e.g., smart phone), and/or other computing devices.

Computing system 150 includes a logic machine 710, a data storage machine 712, and an input/output subsystem 714. As part of input/output subsystem 714, computing system 150 may include a display subsystem, a user input subsystem, a communication subsystem, and/or other components not shown in FIG. 7

Logic machine 710 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 712 includes one or more physical devices configured to hold instructions 720 (e.g., program suite 152 of FIG. 1) and/or other data 722 executable by the logic machine to implement the methods and processes described herein. When such methods and processes are implemented, the state of storage machine 712 may be transformed—e.g., to hold different data.

Storage machine 712 may include removable and/or built-in devices. Storage machine 712 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 712 may include volatile, nonvolatile, dynamic, static, read/write, read-only, random-access, sequential-access, location-addressable, file-addressable, and/or content-addressable devices.

It will be appreciated that storage machine 712 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 710 and storage machine 712 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 150 implemented to perform a particular function. In some cases, a module, program, or engine may be instantiated via logic machine 710 executing instructions held by storage machine 712. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, a display subsystem may be used to present a visual representation of data held by storage machine 712. This visual representation may take the form of a graphical user interface (GUI). As the herein described methods and processes change the data held by the storage machine, and thus transform the state of the storage machine, the state of the display subsystem may likewise be transformed to visually represent changes in the underlying data. A display subsystem may include one or more display devices utilizing virtually any type of technology. Such display devices may be combined with logic machine 710 and/or storage machine 712 in a shared enclosure, or such display devices may be peripheral display devices.

When included, a user input subsystem may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, a communication subsystem may be configured to communicatively couple computing system 150 with one or more other computing devices or computing systems. A communication subsystem may include wired and/or wireless communication devices compatible with one or more different communication protocols. As non-limiting examples, a communication subsystem may be configured for communication via a wireless telephone network, or a wired or wireless local- or wide-area network. In some examples, a communication subsystem may allow computing system 150 to send and/or receive messages to and/or from other devices via a network such as the Internet.

According to an example disclosed herein, a method for measuring terrain coverage comprises: at a computing system: obtaining sample image data representing a multispectral image of a geographic region at a sample resolution; generating, based on the sample image data, an index array of pixels for a subject terrain in which each pixel has an index value that represents a predefined relationship between a first wavelength reflectance and a second wavelength reflectance; providing the index array to a trained calibration model to generate an estimated value based on the index array, the estimated value representing an estimated amount of terrain coverage within the geographic region for the subject terrain; wherein the trained calibration model is previously trained based on training data representing one or more reference images of one or more training geographic regions containing the subject terrain at a higher resolution than the sample resolution; and outputting the estimated value for the subject terrain. In this example or other examples disclosed herein, the trained calibration model was trained by adjusting one or more weights of a function that represents a model-based mapping between the index values of the index array and the estimated value based on a target value generated from each of the one or more reference images. In this example or other examples disclosed herein, the method further comprises training an untrained calibration model to obtain the trained calibration model by: obtaining the one or more training examples in which each training example includes at least: a target value of the subject terrain within a training geographic region that is based on a reference image at the higher resolution, and a training sample image of the subject terrain within the training geographic region at the sample resolution; for each training example of the one or more training examples: providing a training index array of the training sample image to the untrained calibration model to generate a training estimated value based on the training index array, the training estimated value representing an estimated amount of terrain coverage within the training geographic region for the subject terrain, and adjusting one or more parameters of the untrained calibration model based on an error between the training estimated value and the target value over each of the one or more training examples to obtain the trained calibration model. In this example or other examples disclosed herein, each training example further includes a downsampled image of each reference image at the sample resolution; and the method further comprises: downsampling the reference image or an index array of the reference image to obtain the downsampled image; and at a regressor executed by the computing system or another computing system: determining the error over the one or more training examples, and adjusting the one or more parameters based on the error. In this example or other examples disclosed herein, the subject terrain includes vegetation canopy coverage; and the estimated value represents a fractional vegetation canopy coverage for the subject terrain within the geographic region. In this example or other examples disclosed herein, the first wavelength reflectance is near-infrared wavelength reflectance and the second wavelength reflectance is visible, red wavelength reflectance.

According to another example disclosed herein, a method performed by a computing system for training a calibration model for measuring terrain coverage of a geographic region comprises: obtaining a reference image of the geographic region at a reference resolution; determining, based on the reference image, a target value representing an amount of terrain coverage within the geographic region for a subject terrain; obtaining a sample image representing a multispectral image of the geographic region at a sample resolution that is lower than the reference resolution; generating, based on the sample image, an index array of pixels for the subject terrain in which each pixel has an index value that represents a predefined relationship between a first wavelength reflectance and a second wavelength reflectance; providing the index array to the calibration model to generate an estimated value representing an estimated amount of terrain coverage within the geographic region for the subject terrain; determining an error between the target value and the estimated value; and adjusting one or more parameters of the calibration model based on the error to obtain a trained calibration model. In this example or other examples disclosed herein, generating, based on the reference image, an image mask that identifies, for each pixel, whether the subject terrain is present or not present at that pixel; wherein determining the target value is based on the image mask. In this example or other examples disclosed herein, the method further comprises: downsampling the reference image or the image mask to obtain a downsampled image having the sample resolution; and wherein adjusting the one or more parameters of the calibration model is further based on a reference mapping between pixel values of the downsampled image and the target value. In this example or other examples disclosed herein, adjusting the one or more parameters is performed by a regressor executed by the computing system. In this example or other examples disclosed herein, the subject terrain includes vegetation canopy coverage; and the estimated value represents a fractional vegetation canopy coverage for the subject terrain within the geographic region. In this example or other examples disclosed herein, the first wavelength reflectance is near-infrared wavelength reflectance and the second wavelength reflectance is visible, red wavelength reflectance. In this example or other examples disclosed herein, the target value and the index array form part of a training example; and wherein the method further comprises: obtaining a plurality of training examples in which each training example includes a respective target value obtained from a respective reference image at the reference resolution and a respective index array at the sample resolution; and to obtain the trained calibration model, for each of the plurality of training examples: determining a respective error between the target value and an estimated value generated by the calibration model from the index array of that training example, and adjusting one or more parameters of the calibration model based on the respective error. In this example or other examples disclosed herein, the method further comprises: providing a copy of the trained calibration model to another computing system to generate a respective estimated value for the subject terrain at the trained calibration model using a sample image capturing a respective geographic region as input.

According to another example disclosed herein, a computing system or a computing system component comprises: a data storage machine having instructions stored thereon executable by a logic machine to: obtain sample image data representing a multispectral image of a geographic region at a sample resolution; generate, based on the sample image data, an index array of pixels for a subject terrain in which each pixel has an index value that represents a predefined relationship between a first wavelength reflectance and a second wavelength reflectance; provide the index array to a trained calibration model to generate an estimated value based on the index array, the estimated value representing an estimated amount of terrain coverage within the geographic region for the subject terrain; wherein the trained calibration model is previously trained based on training data representing one or more reference images of one or more training geographic regions containing the subject terrain at a higher resolution than the sample resolution; and output the estimated value for the subject terrain. In this example or other examples disclosed herein, the trained calibration model was trained by adjusting one or more weights of a function that represents a model-based mapping between the index values of the index array and the estimated value based on a target value generated from each of the one or more reference images. In this example or other examples disclosed herein, the instructions are further executable by the logic machine to: train an untrained calibration model to obtain the trained calibration model by: obtaining the one or more training examples in which each training example includes at least: a target value of the subject terrain within a training geographic region that is based on a reference image at the higher resolution, and a training sample image of the subject terrain within the training geographic region at the sample resolution; for each training example of the one or more training examples: providing a training index array of the training sample image to the untrained calibration model to generate a training estimated value based on the training index array, the training estimated value representing an estimated amount of terrain coverage within the training geographic region for the subject terrain, and adjusting one or more parameters of the untrained calibration model based on an error between the training estimated value and the target value over each of the one or more training examples to obtain the trained calibration model. In this example or other examples disclosed herein, each training example further includes a downsampled image of each reference image at the sample resolution; and wherein the instructions are further executable by the logic machine to: downsample the reference image or an index array of the reference image to obtain the downsampled image; and at a regressor of the instructions executed by logic machine: determine the error over the one or more training examples, and adjust the one or more parameters based on the error. In this example or other examples disclosed herein, the subject terrain includes vegetation canopy coverage; and the estimated value represents a fractional vegetation canopy coverage for the subject terrain within the geographic region. In this example or other examples disclosed herein, the first wavelength reflectance is near-infrared wavelength reflectance and the second wavelength reflectance is visible, red wavelength reflectance.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for measuring terrain coverage, the method comprising:
at a computing system:
obtaining sample image data representing a multispectral image of a geographic region at a sample resolution;
generating, based on the sample image data, an index array of pixels for a subject terrain in which each pixel has an index value that represents a predefined relationship between a first wavelength reflectance and a second wavelength reflectance;
providing the index array to a trained calibration model to generate an estimated value based on the index array, the estimated value representing an estimated amount of terrain coverage within the geographic region for the subject terrain;
wherein the trained calibration model is previously trained based on training data representing one or more reference images of one or more training geographic regions containing the subject terrain at a higher resolution than the sample resolution; and
outputting the estimated value for the subject terrain.

2. The method of claim 1, wherein the trained calibration model was trained by adjusting one or more weights of a function that represents a model-based mapping between the index values of the index array and the estimated value based on a target value generated from each of the one or more reference images.

3. The method of claim 1, further comprising, training an untrained calibration model to obtain the trained calibration model by:
obtaining the one or more training examples in which each training example includes at least:
a target value of the subject terrain within a training geographic region that is based on a reference image at the higher resolution, and
a training sample image of the subject terrain within the training geographic region at the sample resolution;
for each training example of the one or more training examples:
providing a training index array of the training sample image to the untrained calibration model to generate a training estimated value based on the training index array, the training estimated value representing an estimated amount of terrain coverage within the training geographic region for the subject terrain, and
adjusting one or more parameters of the untrained calibration model based on an error between the training estimated value and the target value over each of the one or more training examples to obtain the trained calibration model.

4. The method of claim 3, wherein each training example further includes a downsampled image of each reference image at the sample resolution; and
wherein the method further comprises:
downsampling the reference image or an index array of the reference image to obtain the downsampled image; and
at a regressor executed by the computing system or another computing system:
determining the error over the one or more training examples, and
adjusting the one or more parameters based on the error.

5. The method of claim 1, wherein the subject terrain includes vegetation canopy coverage; and
wherein the estimated value represents a fractional vegetation canopy coverage for the subject terrain within the geographic region.

6. The method of claim 5, wherein the first wavelength reflectance is near-infrared wavelength reflectance and the second wavelength reflectance is visible, red wavelength reflectance.

7. A method performed by a computing system for training a calibration model for measuring terrain coverage of a geographic region, the method comprising:
obtaining a reference image of the geographic region at a reference resolution;
determining, based on the reference image, a target value representing an amount of terrain coverage within the geographic region for a subject terrain;
obtaining a sample image representing a multispectral image of the geographic region at a sample resolution that is lower than the reference resolution;
generating, based on the sample image, an index array of pixels for the subject terrain in which each pixel has an index value that represents a predefined relationship between a first wavelength reflectance and a second wavelength reflectance;
providing the index array to the calibration model to generate an estimated value representing an estimated amount of terrain coverage within the geographic region for the subject terrain;
determining an error between the target value and the estimated value; and
adjusting one or more parameters of the calibration model based on the error to obtain a trained calibration model.

8. The method of claim 7, further comprising:
generating, based on the reference image, an image mask that identifies, for each pixel, whether the subject terrain is present or not present at that pixel;
wherein determining the target value is based on the image mask.

9. The method of claim 8, further comprising:
downsampling the reference image or the image mask to obtain a downsampled image having the sample resolution; and
wherein adjusting the one or more parameters of the calibration model is further based on a reference mapping between pixel values of the downsampled image and the target value.

10. The method of claim 7, wherein adjusting the one or more parameters is performed by a regressor executed by the computing system.

11. The method of claim 7, wherein the subject terrain includes vegetation canopy coverage; and
wherein the estimated value represents a fractional vegetation canopy coverage for the subject terrain within the geographic region.

12. The method of claim 11, wherein the first wavelength reflectance is near-infrared wavelength reflectance and the second wavelength reflectance is visible, red wavelength reflectance.

13. The method of claim 7, wherein the target value and the index array form part of a training example; and wherein the method further comprising:
obtaining a plurality of training examples in which each training example includes a respective target value obtained from a respective reference image at the reference resolution and a respective index array at the sample resolution; and
to obtain the trained calibration model, for each of the plurality of training examples:
determining a respective error between the target value and an estimated value generated by the calibration model from the index array of that training example, and
adjusting one or more parameters of the calibration model based on the respective error.

14. The method of claim 7, further comprising:
providing a copy of the trained calibration model to another computing system to generate a respective estimated value for the subject terrain at the trained calibration model using a sample image capturing a respective geographic region as input.

15. A computing system component, comprising:
a data storage machine having instructions stored thereon executable by a logic machine to:
obtain sample image data representing a multispectral image of a geographic region at a sample resolution;
generate, based on the sample image data, an index array of pixels for a subject terrain in which each pixel has an index value that represents a predefined relationship between a first wavelength reflectance and a second wavelength reflectance;
provide the index array to a trained calibration model to generate an estimated value based on the index array, the estimated value representing an estimated amount of terrain coverage within the geographic region for the subject terrain;
wherein the trained calibration model is previously trained based on training data representing one or more reference images of one or more training geographic regions containing the subject terrain at a higher resolution than the sample resolution; and
output the estimated value for the subject terrain.

16. The computing system of claim 15, wherein the trained calibration model was trained by adjusting one or more weights of a function that represents a model-based mapping between the index values of the index array and the estimated value based on a target value generated from each of the one or more reference images.

17. The computing system of claim 15, wherein the instructions are further executable by the logic machine to:
train an untrained calibration model to obtain the trained calibration model by:
obtaining the one or more training examples in which each training example includes at least:
a target value of the subject terrain within a training geographic region that is based on a reference image at the higher resolution, and
a training sample image of the subject terrain within the training geographic region at the sample resolution;
for each training example of the one or more training examples:
providing a training index array of the training sample image to the untrained calibration model to generate a training estimated value based on the training index array, the training estimated value representing an estimated amount of terrain coverage within the training geographic region for the subject terrain, and
adjusting one or more parameters of the untrained calibration model based on an error between the training estimated value and the target value over each of the one or more training examples to obtain the trained calibration model.

18. The computing system of claim 17, wherein each training example further includes a downsampled image of each reference image at the sample resolution; and
wherein the instructions are further executable by the logic machine to:
downsample the reference image or an index array of the reference image to obtain the downsampled image; and
at a regressor of the instructions executed by logic machine:
determine the error over the one or more training examples, and
adjust the one or more parameters based on the error.

19. The computing system of claim 15, wherein the subject terrain includes vegetation canopy coverage; and
wherein the estimated value represents a fractional vegetation canopy coverage for the subject terrain within the geographic region.

20. The computing system of claim 19, wherein the first wavelength reflectance is near-infrared wavelength reflectance and the second wavelength reflectance is visible, red wavelength reflectance.
